(19) United States
(12) Patent Application Publication
(10) Pub. No.: US 2024/0299995 A1
(43) Pub. Date: Sep. 12, 2024

(54) COFFEE AND VENDING MACHINE WITH FOOD WASTE MANAGEMENT

(71) Applicants: George Dah Ren CHEN, Hong Kong (CN); Yiu Wen CHANG, Hong Kong (CN)

(72) Inventors: George Dah Ren CHEN, Hong Kong (CN); Yiu Wen CHANG, Hong Kong (CN)

(73) Assignee: Ecoinno (H.K.) Limited, Hong Kong (CN)

(21) Appl. No.: 18/275,401

(22) PCT Filed: Feb. 1, 2022
(86) PCT No.: PCT/IB2022/050846

§ 371 Date: Aug. 1, 2023

Related U.S. Application Data
(60) Provisional application No. 63/144,473, filed on Feb. 1, 2021.

(51) Int. Cl. B09B 3/60; A47J 31/36; A47J 31/44; B02C 23/00; B09B 3/35; B09B 101/70; B65D 85/804; C05F 9/04; G07F 13/10

(52) U.S. Cl. CPC B09B 3/60; A47J 31/3676; A47J 31/44; B02C 23/00; B09B 3/35; B65D 85/8043; C05F 9/04; G07F 13/10; B09B 2101/70

(57) ABSTRACT

A beverage brewing device may include a beverage brewing device for receiving a single-use beverage cartridge, wherein the cartridge contains beverage material for brewing. The beverage brewing device discards the cartridge in response to the brewing. A mill machine disintegrates the cartridge after receiving the cartridge from the beverage brewing device. A compost box for receiving the disintegrated cartridge from the mill machine.

### CROSS-REFERENCE TO RELATED APPLICATIONS

This application claims priority to International Application number PCT/IB22/050846, filed on Feb. 1, 2022, which claims priority to U.S. provisional application, Ser. No. 63/144,473, filed on Feb. 1, 2021, whose disclosure is incorporated by reference in its entirety herein.

### TECHNICAL FIELD

The present disclosure pertains generally to devices and methods related to enhanced coffee or vending machines. In particular, aspects of the invention are related to coffee or vending machines that recycle and convert recycled single-use coffee cartridges, capsules or pods to compost.

### BACKGROUND

Single-serve coffee or beverage brewers have gained popularity in recent years due to its flavor as well as convenience. At the same time, it does not leave the brewed beverage in the open as in the prior approaches where a large container holds a larger quantity on top of a warmer. The beverage's flavor may become stale. As such, this individualized approached to gourmet coffee at home much appreciated by the consumers.

However, one of the biggest drawbacks with these systems are the cartridges and the machines. First, the cartridges are either made of a closed plastic cup or a metallic cup with the beverage material inside, sealed with aluminum foil or other type of cover. Specialized inks are used to print on the plastic and/or aluminum foil to indicate the type of beverage material inside, lot numbers, etc. The cover is often attached to the plastic cup with an adhesive. The cartridges may include a filter inside the plastic cup to reduce and/or minimize the amount of beverage material (e.g., coffee grounds, tea leaves, etc.) that are transferred from the cartridge to a mug, cup, and/or other receptacle that a person would use for drinking the resultant beverage. These cartridges are not recycled properly and most of them are not suitable for home composting. Therefore, it is creating a tremendous amount of waste footprint for the next generation.

In addition, the coffee machines that accept these cartridges are not capable of facilitating the home composting.

On the other end of the spectrum, vending machines at cafeterias also lack the ability to facilitate waste managements. One of the primary reasons is that most of the containers sold in the vending machines are not recyclable, let alone compostable.

Therefore, improved coffee machines and/or vending machines that can facilitate better food waste management are needed.

### SUMMARY

Aspects of the present disclosure include a method and system for improved composting within or connected to coffee machines and vending machines. Aspects of the invention provide a blender, a crusher, a slicer, a shredder, or a mill to break down compostable food containers. In another embodiment, aspects of the invention provide a condition for home composting so that the milled container pieces are housed with the coffee powders or food waste.

### BRIEF DESCRIPTION OF THE DRAWINGS

Persons of ordinary skill in the art may appreciate that elements in the figures are illustrated for simplicity and clarity so not all connections and options have been shown. For example, common but well-understood elements that are useful or necessary in a commercially feasible embodiment may often not be depicted in order to facilitate a less obstructed view of these various embodiments of the present disclosure. It may be further appreciated that certain actions and/or steps may be described or depicted in a particular order of occurrence while those skilled in the art may understand that such specificity with respect to sequence is not actually required. It may also be understood that the terms and expressions used herein may be defined with respect to their corresponding respective areas of inquiry and study except where specific meanings have otherwise been set forth herein.

FIG. 1 is a schematic view of one embodiment of a coffee system according to an aspect of the present disclosure.

FIG. 2 is another schematic view of another embodiment of a vending system in accordance with an aspect of the present disclosure.

### DETAILED DESCRIPTION

Embodiments may now be described more fully with reference to the accompanying drawings, which form a part hereof, and which show, by way of illustration, specific exemplary embodiments which may be practiced. These illustrations and exemplary embodiments may be presented with the understanding that the present disclosure is an exemplification of the principles of one or more embodiments and may not be intended to limit any one of the embodiments illustrated. Embodiments may be embodied in many different forms and should not be construed as limited to the embodiments set forth herein; rather, these embodiments are provided so that this disclosure may be thorough and complete, and may fully convey the scope of embodiments to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description may, therefore, not to be taken in a limiting sense.

Inventors of the present application have identified a revolutionary material, method of making, a system thereof, or the like that is disclosed in one or more patents, applications, and those applications or patents that claim priority thereto here: U.S. patent application Ser. Nos. 62/299,084; 13/878,986; 14/886,792; 15/353,212; 15/812,505; 16/079,463; 16/531,673; 63/019,845; 63/019,849; 63/019,852; 63/063,210, and their related applications.

One of the biggest advancements in the inventors' innovations is creating a natural material that is generally free of toxic or harmful chemicals that are typically associated with food or beverage containers. Coatings or laminations such as Per- and polyfluoroalkyl substances (PFAS) or bisphenol-A (BPA) in plastics are not used in the innovative green composite material (GCM). In addition, GCM lacks elements of bioplastics such as:
Starch-based
Cellulose-based: cellulose pulp from trees
Polyhydroxyalkanoates (Polyhydroxybutyrate) (PHA, PHB)—Microbial source
Polylactides (PLA)—Lactic acid by fermentation

As such, GCM is perfect for home composting. For additional disclosure, please refer to the Specification's Attachment.

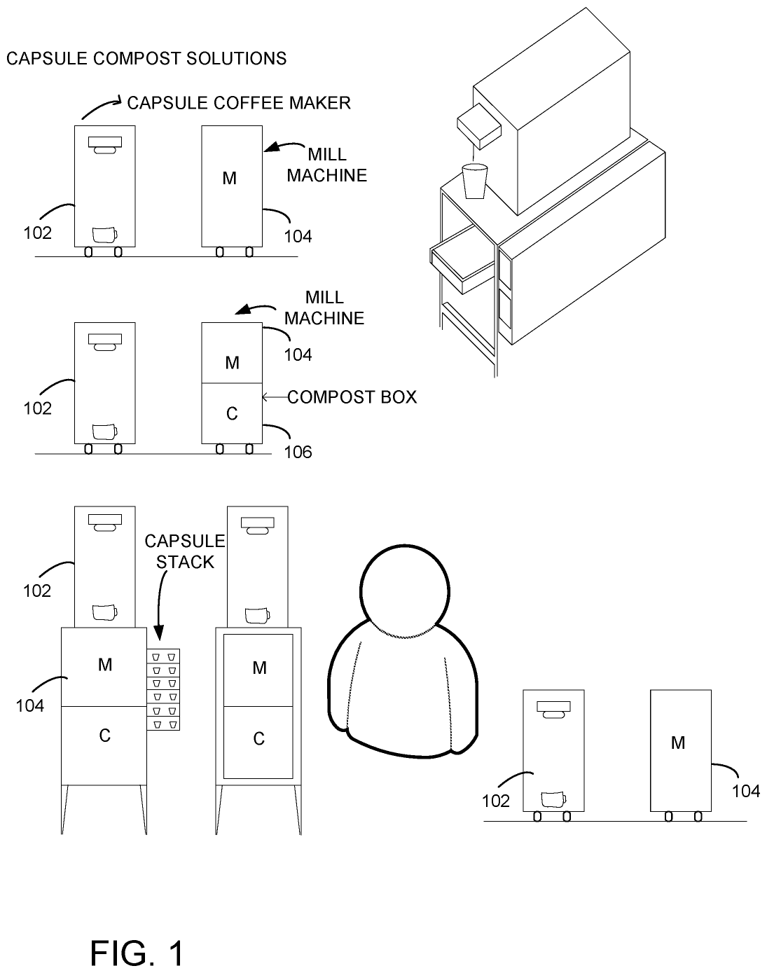

Referring to FIG. 1, a schematic of a beverage system according to some embodiments. In one embodiment, a device 102 may be a coffee machine 102 which may be used to receive single-use beverage cartridges or pods. In one embodiment, it is understood that the coffee machine 102 may be other types of beverage maker as long as the beverage source is stored within a one-time or single-use cartridge or pod.

In one aspect, the coffee machine 102 may be connected with a mill machine 104. In one embodiment, the mill machine 104 may be a blender, a slicer, a crusher, a shredder, or the like. In yet another embodiment, the mill machine 104 may disintegrate the cartridge. In another embodiment, the mill machine 104 may receive the used singled-use cartridge from the coffee machine 102 after brewing or the materials inside the cartridge is used. In one embodiment, the singled-use cartridge may be inserted by a consumer to the mill machine 104. In another embodiment, the singled-use cartridge may be dropped or lowered from the coffee machine 102 to the mill machine 104, as shown in FIG. 1.

In another embodiment, a compost box 106 may further be part of the mill machine 104. In other words, after the singled-use cartridge is crushed, sliced, blended, shredded, or the like, the content thereof, along with the beverage residue (e.g., coffee or tea leafs), may be lowered to the compost box 106. In one embodiment, the compost box 106 and the mill machine 104 may be separated except for a chute or conduit where the crushed, sliced, blended, or shredded singled-use cartridge is passed from the mill machine 104 to the compost box 106. The compost box 106 may include a lid or a valve to close the chute or conduit when the crushed contents are not lowered from the mill machine 104. In yet another embodiment, a timer may be used to control the opening and closing of the lid or valve.

As the singled-use cartridge made of GCM is fiber-based, the crushed, sliced, blended, or shredded singled-use cartridge may be home compost. Unlike industrial compost condition, home compost does not require additional heating or other treatment of the waste source to facilitate the composting. In another embodiment, the fiber-based cartridges or containers may be made of a material that is primarily fiber-based. In yet another embodiment, the fiber-based cartridges or containers may include a blend of fiber and other polymers.

In another embodiment, a number of different configurations may be provided without departing from the scope and spirit of aspects of the invention. For example, the coffee machine 102, the mill machine 104, and the compost box 106 may be in a vertical configuration with separate configurations. In another embodiment, the combinations may be that the coffee machine 102 and a combined mill machine and the compost box. In yet another embodiment, the coffee machine 102 and the mill machine 104 may be an integrated configuration with the compost box be a separate unit.

In one embodiment, the coffee machine 102 and the mill machine 104 may have wireless connectivity to connect with mobile devices so that alerts and control configurations may be interchanged between the mobile devices and the coffee machine 102 and the mill machine 104.

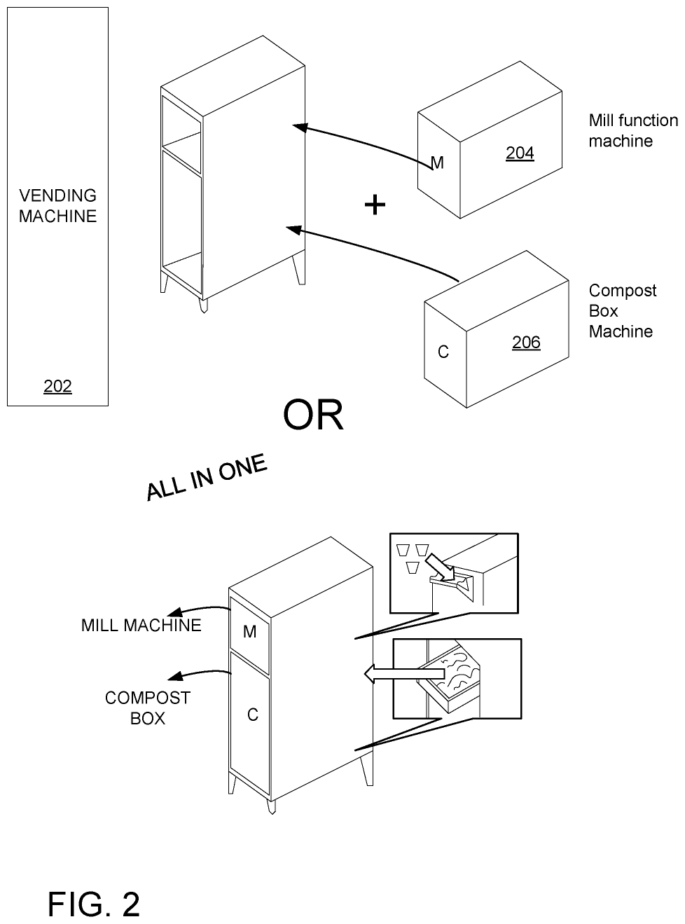

Similar to the above disclosure, the coffee machine 102 may be further expanded to vending machines as seen in FIG. 2.

In another embodiment, a number of different configurations may be provided without departing from the scope and spirit of aspects of the invention. For example, the vending machine 202, the mill machine 104, and the compost box 106 may be in a vertical configuration with separate configurations. In another embodiment, the combinations may be that the vending machine 202 and a combined mill machine and the compost box. In yet another embodiment, the vending machine 202 and the mill machine 104 may be an integrated configuration with the compost box be a separate unit.

In one embodiment, the vending machine 202 and the mill machine 104 may have wireless connectivity to connect with mobile devices so that alerts and control configurations may be interchanged between the mobile devices and the vending machine 202 and the mill machine 104.

In yet another embodiment, the vending machine 202 may be connected to a heat source or a cooling source. For example, the vending machine 202 may be connected to a refrigeration system that may keep the fiber-based containers in a certain temperature. In yet another embodiment, the vending machine 202 may include a steamer connect thereto where the fiber-based containers may be heated before serving to the consumer. In an alternative embodiment, the vending machine 202 or the mill machine 104 may include or be connected to a water source or moisture source to wet the crushed or shredded materials so as to accelerate milling process.

The above description is illustrative and is not restrictive. Many variations of embodiments may become apparent to those skilled in the art upon review of the disclosure. The scope embodiments should, therefore, be determined not with reference to the above description, but instead should be determined with reference to the pending claims along with their full scope or equivalents.

One or more features from any embodiment may be combined with one or more features of any other embodiment without departing from the scope embodiments. A recitation of “a”, “an” or “the” is intended to mean “one or more” unless specifically indicated to the contrary. Recitation of “and/or” is intended to represent the most inclusive sense of the term unless specifically indicated to the contrary.

While the present disclosure may be embodied in many different forms, the drawings and discussion are presented with the understanding that the present disclosure is an exemplification of the principles of one or more inventions and is not intended to limit any one embodiments to the embodiments illustrated.

The present disclosure provides a solution to the long-felt need described above. In particular, aspects of the invention overcome challenges of relying on existing practices of discarding the coffee capsules or unable to properly recycle these waste.

Further advantages and modifications of the above described system and method may readily occur to those skilled in the art.

The disclosure, in its broader aspects, is therefore not limited to the specific details, representative system and methods, and illustrative examples shown and described above. Various modifications and variations may be made to the above specification without departing from the scope or spirit of the present disclosure, and it is intended that the present disclosure covers all such modifications and variations provided they come within the scope of the following claims and their equivalents.

What is claimed is:

1. A beverage brewing device comprising:
a beverage brewing device for receiving a single-use beverage cartridge, wherein the cartridge contains beverage material for brewing;
wherein the beverage brewing device discards the cartridge in response to the brewing;
a mill machine disintegrates the cartridge after receiving the cartridge from the beverage brewing device; and
a compost box for receiving the disintegrated cartridge from the mill machine.

2. The beverage brewing device of claim 1, further comprising a conduit connecting between the mill machine and the compost box.

3. The beverage brewing device of claim 2, further comprising a valve controlling openings and closings of the conduit.

4. The beverage brewing device of claim 1, wherein the mill machine comprises a blender.

5. The beverage brewing device of claim 1, wherein the single-use beverage cartridge comprises a fiber-based single-use coffee cartridge.

6. A vending machine comprising:
a housing for storing one or more fiber-based single-use containers for consumable items;
a display for displaying the consumable items to users for purchase;
a moving module for moving the one or more fiber-based single-use containers for retrieval by the users after the purchase is completed;
a receiving window for receiving the one or more fiber-based single-use containers after the consumable items are consumed;
a mill machine for generating a byproduct after disintegrating the received one or more fiber-based single-use containers from the receiving window; and
a compost box for receiving the byproduct from the mill machine.
